(19) United States
(12) Patent Application Publication
(10) Pub. No.: US 2025/0358654 A1
(43) Pub. Date: Nov. 20, 2025

(54) METHOD AND APPARATUS FOR MITIGATION OF DROPPED SCHEDULING

(71) Applicant: NOKIA TECHNOLOGIES OY, Espoo (FI)

(72) Inventors: Bent Henneberg RYSGAARD, Aalborg (DK); Rafael CAUDURO DIAS DE PAIVA, Aalborg (DK); Jurgen HOFMANN, Espoo (FI); Lars DALSGAARD, Oulu (FI)

(21) Appl. No.: 18/667,081

(22) Filed: May 17, 2024

(51) Int. Cl. H04W 24/10

(52) U.S. Cl. CPC H04W 24/10

(57) ABSTRACT

A method, apparatus, and computer program product are provided for handling communication sessions without measurement gaps. As described herein, a method may include: initiating a communication session with a network; providing, to the network, an indication that the communication session will be conducted without measurement gaps; providing an indication of one of a defined interruption rate or an undefined interruption rate for the communication session conducted without measurement gaps; and conducting the communication session without measurement gaps and according to the one of the defined interruption rate or the undefined interruption rate for the communication session.

### TECHNOLOGICAL FIELD

A method, apparatus, and computer program product are provided for handling communication sessions without measurement gaps, and more particularly, to defining parameters of a communication session that is conducted without measurement gaps but with interruptions and mitigating the impact of interruptions on the communication session.

### BACKGROUND

Various wireless communications rely on measurements and/or measurement gaps. For example, measurements allow for mobility of user devices. A configured measurement gap prevents a user device from being scheduled for the duration of the measurement gap, which may result in an increase in transmit latency.

Scheduling delays and interruptions may increase due to measurement gaps. For example, if data arrives shortly before a measurement gap, a network may only be able to schedule the user device to receive data in the next downlink slot after the measurement gap. This can lead to results such as the network not dynamically reacting to new information, for example, such as the arrival of new higher priority downlink data during or shortly before the measurement gap. Thus, the latency of the user device increases by a large fraction of the overall latency budget, for example, in various use cases.

Increasingly user equipment is available that supports measurement without measurement gaps. Such user equipment may not require a measurement gap, but may introduce interruptions, such as an instance in which a UE may not receive or transmit data. The unknown interruptions and dropped scheduling occasions have a relatively high interruption ratio which has a negative impact on the network, the user equipment, and the system in general.

### BRIEF SUMMARY

A method, apparatus, and computer program product are provided for handling communication sessions without measurement gaps, and more particularly, to defining parameters of a communication session that is conducted without measurement gaps but with interruptions and mitigating the impact of interruptions on the communication session. Certain embodiments include an apparatus including at least one processor and at least one memory storing instructions, that when executed by the at least one processor, cause the apparatus to at least: initiate a communication session with a network; provide, to the network, an indication that the communication session will be conducted without measurement gaps; provide an indication of one of a defined interruption rate or an undefined interruption rate for the communication session conducted without measurement gaps; and conduct the communication session without measurement gaps and according to the one of the defined interruption rate or the undefined interruption rate for the communication session.

According to some embodiments, causing the apparatus to provide the indication of the one of the defined interruption rate or the undefined interruption rate includes causing the apparatus to provide the indication of the defined interruption rate and a permissible rate of interruption. The apparatus of some embodiments is further caused to receive an indication of a configuration from a network according to the indication of the defined interruption rate. The apparatus of some embodiments is further caused to conduct the communication session with the network without measurement gaps and according to the indication of the defined interruption rate.

The apparatus of some embodiments is further caused to provide for interruptions of the communication session at a rate that does not exceed the permissible rate of interruption. According to some embodiments the interruptions of the communication session are provided in order to perform signal measurements.

According to some embodiments, causing the apparatus to provide the indication of the one of the defined interruption rate or the undefined interruption rate includes causing the apparatus to provide the indication of the undefined interruption rate. The apparatus of certain embodiments is further caused to receive an indication of a configuration from a network according to the indication of the undefined interruption rate. The apparatus of certain embodiments is further caused to conduct the communication session with the network without measurement gaps according to the indication of the undefined interruption rate.

The apparatus of certain embodiments is further caused to provide for interruptions of the communication session at a rate that does not exceed a permissible rate of interruption defined according to a specification associated with the apparatus. According to some embodiments the interruptions of the communication session are provided for performing signal measurements.

Certain embodiments include an apparatus including at least one processor and at least one memory storing instructions, that when executed by the at least one processor, cause the apparatus to at least: receive a request for a communication session from a user equipment device; receive an indication that the communication session will be conducted without measurement gaps; receive an indication of one of a defined interruption rate or an undefined interruption rate for the communication session; and conduct the communication session without measurement gaps and according to the one of the defined interruption rate or the undefined interruption rate for the communication session.

According to some embodiments, causing the apparatus to receive the indication of the one of the defined interruption rate or the undefined interruption rate includes causing the apparatus to receive the indication of the defined interruption rate and a permissible rate of interruption. The apparatus of some embodiments is further caused to provide an indication of a configuration to the user equipment device according to the indication of the defined interruption rate. The apparatus of some embodiments is further caused to conduct the communication session with the user equipment device according to the indication of the defined interruption rate.

The apparatus of some embodiments is further caused to mitigate an impact of interruptions of the communication session at a rate that does not exceed the permissible rate of interruption. According to some embodiments, causing the apparatus to mitigate the impact of the interruptions of the communication session includes causing the apparatus to reduce an impact of lost resources on the communication session. According to certain embodiments, causing the apparatus to receive the indication of the one of the defined interruption rate or the undefined interruption rate includes causing the apparatus to receive the indication of the undefined interruption rate.

The apparatus of some embodiments is further caused to provide an indication of a configuration to the user equipment device according to the indication of the undefined interruption rate. The apparatus of some embodiments is further caused to conduct the communication session with the user equipment device without measurement gaps and according to the indication of the undefined interruption rate. The apparatus of some embodiments is further caused to mitigate an impact interruptions of the communication session at a rate that does not exceed a permissible rate of interruption defined according to a specification associated with the user equipment device. According to some embodiments, causing the apparatus to mitigate an impact of the interruptions of the communication session includes causing the apparatus to reduce an impact of lost resources on the communication session.

Certain embodiments provided herein include a method including: initiating a communication session with a network; providing, to the network, an indication that the communication session will be conducted without measurement gaps; providing an indication of one of a defined interruption rate or an undefined interruption rate for the communication session conducted without measurement gaps; and conducting the communication session without measurement gaps and according to the one of the defined interruption rate or the undefined interruption rate for the communication session.

According to some embodiments, providing the indication of the one of the defined interruption rate or the undefined interruption rate includes providing the indication of the defined interruption rate and a permissible rate of interruption. The method of some embodiments includes receiving an indication of a configuration from a network according to the indication of the defined interruption rate. The method of certain embodiments includes conducting the communication session with the network without measurement gaps and according to the indication of the defined interruption rate.

The method of some embodiments includes providing for interruptions of the communication session at a rate that does not exceed the permissible rate of interruption. According to certain embodiments the interruptions of the communication session are provided in order to perform signal measurements.

According to some embodiments, providing the indication of the one of the defined interruption rate or the undefined interruption rate includes providing the indication of the undefined interruption rate. The method of some embodiments includes receiving an indication of a configuration from a network according to the indication of the undefined interruption rate. The method of certain embodiments includes conducting the communication session with the network without measurement gaps according to the indication of the undefined interruption rate.

The method of some embodiments includes providing for interruptions of the communication session at a rate that does not exceed a permissible rate of interruption defined according to a specification associated with the apparatus. According to some embodiments the interruptions of the communication session are provided for performing signal measurements. The method of some embodiments includes performing signal measurements as interruptions of the communication session at a rate that does not exceed a permissible rate of interruption defined according to a specification associated with the apparatus.

Certain embodiments provided herein include a method including: receiving a request for a communication session from a user equipment device; receiving an indication that the communication session will be conducted without measurement gaps; receiving an indication of one of a defined interruption rate or an undefined interruption rate for the communication session; and conducting the communication session without measurement gaps and according to the one of the defined interruption rate or the undefined interruption rate for the communication session. According to some embodiments receiving the indication of the one of the defined interruption rate or the undefined interruption rate includes receiving the indication of the defined interruption rate and a permissible rate of interruption.

The method of some embodiments includes providing an indication of a configuration to the user equipment device according to the indication of the defined interruption rate. The method of certain embodiments includes conducting the communication session with the user equipment device according to the indication of the defined interruption rate. The method of some embodiments includes receiving interruptions of the communication session at a rate that does not exceed the permissible rate of interruption.

According to certain embodiments the interruptions of the communication session are received for to perform signal measurements. According to some embodiments receiving the indication of the one of the defined interruption rate or the undefined interruption rate includes receiving the indication of the undefined interruption rate. The method of some embodiments includes providing an indication of a configuration to the user equipment device according to the indication of the undefined interruption rate.

The method of certain embodiments includes conducting the communication session with the user equipment device without measurement gaps and according to the indication of the undefined interruption rate. The method of some embodiments includes receiving interruptions of the communication session at a rate that does not exceed a permissible rate of interruption defined according to a specification associated with the user equipment device. According to some embodiments the interruptions of the communication session are received to conduct signal measurements.

Certain embodiments provided herein include a computer program product including at least one non-transitory computer-readable storage medium having computer-executable program code portions stored therein, the computer-executable program code portions including program code instructions configured to: initiate a communication session with a network; provide, to the network, an indication that the communication session will be conducted without measurement gaps; provide an indication of one of a defined interruption rate or an undefined interruption rate for the communication session conducted without measurement gaps; and conduct the communication session without measurement gaps and according to the one of the defined interruption rate or the undefined interruption rate for the communication session.

According to some embodiments, the program code instructions to provide the indication of the one of the defined interruption rate or the undefined interruption rate includes program code instructions to provide the indication of the defined interruption rate and a permissible rate of interruption. The computer program product of some embodiments further includes program code instructions to receive an indication of a configuration from a network according to the indication of the defined interruption rate. The computer program product of some embodiments further includes program code instructions to conduct the communication session with the network without measurement gaps and according to the indication of the defined interruption rate.

The computer program product of some embodiments further includes program code instructions to provide for interruptions of the communication session at a rate that does not exceed the permissible rate of interruption. According to some embodiments the interruptions of the communication session are provided in order to perform signal measurements.

According to some embodiments, the program code instructions to provide the indication of the one of the defined interruption rate or the undefined interruption rate includes program code instructions to provide the indication of the undefined interruption rate. The computer program product of some embodiments further includes program code instructions to receive an indication of a configuration from a network according to the indication of the undefined interruption rate. The computer program product of some embodiments further includes program code instructions to conduct the communication session with the network without measurement gaps according to the indication of the undefined interruption rate.

The computer program product of some embodiments further includes program code instructions to provide for interruptions of the communication session at a rate that does not exceed a permissible rate of interruption defined according to a specification associated with the apparatus. According to some embodiments the interruptions of the communication session are provided for performing signal measurements. The computer program product of some embodiments further includes program code instructions to perform signal measurements as interruptions of the communication session at a rate that does not exceed a permissible rate of interruption defined according to a specification associated with the apparatus.

Certain embodiments provided herein include a computer program product including at least one non-transitory computer-readable storage medium having computer-executable program code portions stored therein, the computer-executable program code portions including program code instructions configured to: receive a request for a communication session from a user equipment device; receive an indication that the communication session will be conducted without measurement gaps; receive an indication of one of a defined interruption rate or an undefined interruption rate for the communication session; and conduct the communication session without measurement gaps and according to the one of the defined interruption rate or the undefined interruption rate for the communication session.

According to some embodiments, the program code instructions to receive the indication of the one of the defined interruption rate or the undefined interruption rate includes program code instructions to receive the indication of the defined interruption rate and a permissible rate of interruption. The computer program product of some embodiments further includes program code instructions to provide an indication of a configuration to the user equipment device according to the indication of the defined interruption rate. The computer program product of some embodiments further includes program code instructions to conduct the communication session with the user equipment device according to the indication of the defined interruption rate.

The computer program product of some embodiments further includes program code instructions to mitigate an impact of interruptions of the communication session at a rate that does not exceed the permissible rate of interruption. According to some embodiments, the program code instructions to mitigate an impact of the interruptions of the communication session includes program code instructions to reduce an impact of lost resources on the communication session. According to certain embodiments, the program code instructions to receive the indication of the one of the defined interruption rate or the undefined interruption rate includes program code instructions to receive the indication of the undefined interruption rate.

The computer program product of some embodiments further includes program code instructions to provide an indication of a configuration to the user equipment device according to the indication of the undefined interruption rate. The computer program product of some embodiments further includes program code instructions to conduct the communication session with the user equipment device without measurement gaps and according to the indication of the undefined interruption rate. The computer program product of some embodiments further includes program code instructions to mitigate an impact interruptions of the communication session at a rate that does not exceed a permissible rate of interruption defined according to a specification associated with the user equipment device. According to some embodiments, the program code instructions to mitigate the impact of the interruptions of the communication session includes program code instructions to reduce an impact of lost resources on the communication session.

Certain embodiments provided herein include an apparatus including: means for initiating a communication session with a network; means for providing, to the network, an indication that the communication session will be conducted without measurement gaps; means for providing an indication of one of a defined interruption rate or an undefined interruption rate for the communication session conducted without measurement gaps; and means for conducting the communication session without measurement gaps and according to the one of the defined interruption rate or the undefined interruption rate for the communication session.

According to some embodiments, the means for providing the indication of the one of the defined interruption rate or the undefined interruption rate includes means for providing the indication of the defined interruption rate and a permissible rate of interruption. The apparatus of some embodiments includes means for receiving an indication of a configuration from a network according to the indication of the defined interruption rate. The apparatus of certain embodiments includes means for conducting the communication session with the network without measurement gaps and according to the indication of the defined interruption rate.

The apparatus of some embodiments includes means for providing for interruptions of the communication session at a rate that does not exceed the permissible rate of interruption. According to certain embodiments the interruptions of the communication session are provided in order to perform signal measurements.

According to some embodiments, the means for providing the indication of the one of the defined interruption rate or the undefined interruption rate includes means for providing the indication of the undefined interruption rate. The apparatus of some embodiments includes means for receiving an indication of a configuration from a network according to the indication of the undefined interruption rate. The apparatus of certain embodiments includes means for conducting the communication session with the network without measurement gaps according to the indication of the undefined interruption rate.

The apparatus of some embodiments includes means for providing for interruptions of the communication session at a rate that does not exceed a permissible rate of interruption defined according to a specification associated with the apparatus. According to some embodiments the interruptions of the communication session are provided for performing signal measurements. The apparatus of some embodiments includes means for performing signal measurements as interruptions of the communication session at a rate that does not exceed a permissible rate of interruption defined according to a specification associated with the apparatus.

Certain embodiments provided herein include an apparatus including: means for receiving a request for a communication session from a user equipment device; means for receiving an indication that the communication session will be conducted without measurement gaps; means for receiving an indication of one of a defined interruption rate or an undefined interruption rate for the communication session; and means for conducting the communication session without measurement gaps and according to the one of the defined interruption rate or the undefined interruption rate for the communication session. According to some embodiments the means for receiving the indication of the one of the defined interruption rate or the undefined interruption rate includes means for receiving the indication of the defined interruption rate and a permissible rate of interruption.

The apparatus of some embodiments includes means for providing an indication of a configuration to the user equipment device according to the indication of the defined interruption rate. The apparatus of certain embodiments includes means for conducting the communication session with the user equipment device according to the indication of the defined interruption rate. The apparatus of some embodiments includes means for receiving interruptions of the communication session at a rate that does not exceed the permissible rate of interruption.

According to certain embodiments the interruptions of the communication session are received for to perform signal measurements. According to some embodiments the means for receiving the indication of the one of the defined interruption rate or the undefined interruption rate includes means for receiving the indication of the undefined interruption rate. The apparatus of some embodiments includes means for providing an indication of a configuration to the user equipment device according to the indication of the undefined interruption rate.

The apparatus of certain embodiments includes means for conducting the communication session with the user equipment device without measurement gaps and according to the indication of the undefined interruption rate. The apparatus of some embodiments includes means for receiving interruptions of the communication session at a rate that does not exceed a permissible rate of interruption defined according to a specification associated with the user equipment device. According to some embodiments the interruptions of the communication session are received to conduct signal measurements.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a diagram of a communication system according to an example embodiment of the present disclosure;

FIG. 2 is a block diagram of an apparatus that may be specifically configured in accordance with an example embodiment of the present disclosure;

FIG. 3 is a communication diagram of a process for handling communication sessions without measurement gaps according to an example embodiment of the present disclosure;

FIG. 4 is an information element of the process for handling communication sessions without measurement gaps according to an example embodiment of the present disclosure;

FIG. 5 is a communication diagram of a process for handling communication sessions without measurement gaps according to an example embodiment of the present disclosure;

FIG. 6 is a table depicting interruption rates for communication sessions for various software and firmware configurations according to an example embodiment of the present disclosure;

FIG. 7 is a table depicting additional interruption rates for communication sessions for various software and firmware configurations according to an example embodiment of the present disclosure;

FIG. 8 is a table depicting further interruption rates for communication sessions for various software and firmware configurations according to an example embodiment of the present disclosure;

FIGS. 9-20 are a communication diagram of a processes for handling communication sessions without measurement gaps according to an example embodiment of the present disclosure;

FIG. 21 is a flow chart illustrating the operations performed, such as by the apparatus of FIG. 2 as embodied by a user device, for handling communication sessions without measurement gaps according to an example embodiment of the present disclosure; and

FIG. 22 is a flow chart illustrating the operations performed, such as by the access node of FIG. 1 which may be embodied by the apparatus of FIG. 2, for handling communication sessions without measurement gaps according to an example embodiment of the present disclosure.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with example embodiments of the present disclosure. Thus, use of any such terms should not be taken to limit the spirit and scope of example embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

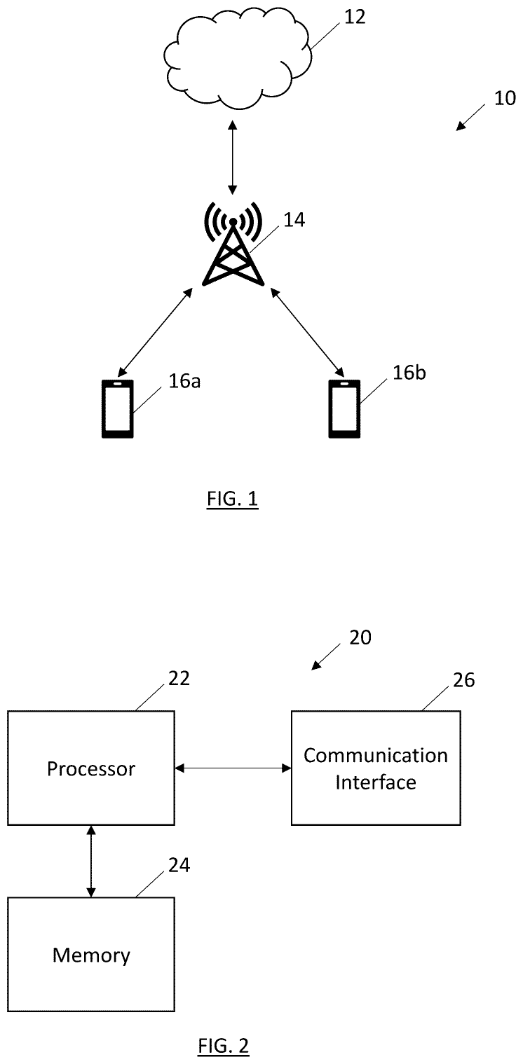

One example of a communications system 10 in which an example embodiment may be deployed is depicted in FIG. 1. The system of FIG. 1 may be utilized for a variety of applications. For example, a communications system 10 may include at least one core network 12, at least one base station 14 (e.g., gNB, NodeB, etc.), and/or at least one user device 16 (16a, b, . . . . N) (e.g., user equipment (UE), wireless device, user terminal, terminal device, etc.).

In FIG. 1, user devices 16a and 16b are configured to be in a wireless connection on one or more communication channels in a cell with an access node (such as a NodeB) 14 providing the cell. The physical link from a user device to a NodeB is called the uplink or reverse link and the physical link from the NodeB to the user device is called the downlink or forward link. It should be appreciated that the NodeBs or their functionalities may be implemented by using any node, host, server, or access point (AP), and/or other entity suitable for such a usage.

A communications system typically comprises more than one NodeB, in which case the NodeBs may also be configured to communicate with one another over links, wired or wireless, designed for the purpose. These links may be used for signaling purposes. The NodeB is a computing device configured to control resources of the communication system to which the NodeB is coupled. The NodeB may also be referred to as a base station, an access point or any other type of interfacing device including a relay station capable of operating in a wireless environment.

The user device illustrates one type of an apparatus or user equipment to which resources on the air interface are allocated and assigned, and thus any feature described herein with a user device may be implemented with a corresponding apparatus, such as the apparatus of FIG. 2.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device is configured to perform one or more of user equipment functionalities. The user device may also be called a subscriber unit, mobile station, remote terminal, access terminal, user terminal or user equipment (UE) just to mention but a few names or apparatuses.

Although an example embodiment may be deployed in various types of communications systems, a 5G communications system will be described herein by way of example, but not of limitation, and the method and apparatus of an example embodiment may be utilized in conjunction with other communication systems, such as 5G-Advanced, 6G, and/or the like. 5G enables using multiple input-multiple output (MIMO) antennas, many more base stations or nodes than LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications, including vehicular safety, different sensors, and real-time control. 5G may have various radio interfaces, namely below 6 GHz, cmWave and mmWave, and also being integratable with existing legacy radio access technologies, such as LTE. Integration with LTE may be implemented, at least in the early phase, as a system, where macro coverage is provided by LTE and 5G radio interface access comes from small cells by aggregation to LTE. In other words, 5G is planned to support both inter-RAT operability (such as LTE-5G) and inter-RI operability (inter-radio interface operability, such as below 6 GHZ-cmWave, below 6 GHZ-cmWave-mm Wave). One of the concepts considered to be used in 5G networks is network slicing in which multiple independent and dedicated virtual sub-networks (network instances) may be created within the same infrastructure to run services that have different requirements on latency, reliability, throughput, and mobility.

The current architecture in LTE networks is fully distributed in the radio and fully centralized in the core network. The low latency applications and services in 5G require bringing the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets, and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), and critical communications (autonomous vehicles, traffic safety, real-time analytics, time-critical control, and healthcare applications).

The communication system 10 is also able to communicate with other networks, such as a public switched telephone network or the Internet, or utilize services provided by them. The communication network 10 may also be able to support the usage of cloud services, for example at least part of core network operations may be carried out as a cloud service. The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes, or hosts. Application of cloudRAN architecture enables RAN real time functions being carried out at the RAN side and non-real time functions being carried out in a centralized manner).

It should also be understood that the distribution of labor between core network operations and base station operations may differ from that of LTE or even be non-existent. Some other technology advancements that may be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The depicted system is only an example of a part of a radio access system in which the system 10 of FIG. 1 may be deployed and in practice, the system may comprise a plurality of NodeBs, the user devices may have access to a plurality of radio cells and the system may comprise also other apparatuses, such as physical layer relay nodes or other network elements, etc. At least one of the NodeBs or may be a Home NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The NodeBs of FIG. 1 may provide any kind of these cells. A cellular radio system may be implemented as a multilayer network including several kinds of cells. Typically, in multilayer networks, one access node provides one kind of a cell or cells, and thus a plurality of NodeBs is required to provide such a network structure.

For fulfilling the need for improving the deployment and performance of communication systems, the concept of “plug-and-play” NodeBs has been introduced. Typically, a network which is able to use “plug-and-play” Node Bs, includes, in addition to Home NodeBs (HnodeBs), a home node B gateway, or HNB-GW. A HNB Gateway (HNB-GW), which is typically installed within an operator's network may aggregate traffic from a large number of HNBs back to a core network. Although FIG. 1 depicts one example communication system in which system 10 of an example embodiment may be deployed, the system of other example embodiments may be deployed in other types of systems, be they to support communications or otherwise.

One example of an apparatus 20 that may be configured to function as the core network 12, base station 14, and/or user device 16 is depicted in FIG. 2. As shown in FIG. 2, the apparatus includes, is associated with or is in communication with processing circuitry 22, a memory 24 and a communication interface 26. The processing circuitry may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

FIG. 2 depicts an example of a simplified block diagram of an apparatus according to various embodiments of the present disclosure, whose implementation may differ from what is shown. The connections shown in FIG. 2 are logical connections; the actual physical connections may be different. It is apparent to a person skilled in the art that the system typically comprises also other functions and structures than those shown in FIG. 2.

The apparatus 20 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processing circuitry 22 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 22 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 22 may be configured to execute instructions stored in the memory device 24 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively or additionally, as another example, when the processing circuitry is embodied as an executor of instructions, the instructions may specifically configure the processor to perform the algorithms and/or operations described herein when the instructions are executed. However, in some cases, the processing circuitry 22 may be a processor of a specific device (e.g., an image or video processing system) configured to employ an embodiment of the present disclosure by further configuration of the processing circuitry by instructions for performing the algorithms and/or operations described herein. The processing circuitry 22 may include, among other things, a clock, an arithmetic logic unit (ALU) and logic gates configured to support operation of the processing circuitry.

The communication interface 26 may be any means such as a device or circuitry embodied in either hardware or a combination of hardware and software that is configured to receive and/or transmit data, including media content in the form of video or image files, one or more audio tracks or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

A significant issue in network communication is the wide array of different hardware devices operating on the network, the operating systems and versions of software operating on devices, and the various potential incompatibilities among the devices. Different user equipment mobile devices or apparatuses such as apparatus 20 of FIG. 2 may handle measurement gaps during communication sessions in different ways. During a communication session one type of mobile device may perform signal measurements without measurement gaps and without causing interruptions, while another mobile device type may perform signal measurements without gaps but causes interruptions, while another type of mobile device may perform measurements only with measurement gaps and not causing interruptions. These unknown interruptions and dropped scheduling occasions with a very high interruption ratio has a significant negative impact on the network side, the user equipment devices, and the system in general during communication sessions. For example, interruptions of a communication session are caused autonomously by the user equipment device without network knowledge. The network scheduler would not know the reason why certain packages are dropped-whether it is due to scheduling issues, air interface, or is it due to interruptions. This may lead to reduced scheduling efficiency which adversely impacts the system as well as the user equipment devices and network.

The challenge relates to a problem caused by prior 3GPP release levels which mean that some chipset vendors already have implementations and designs based on the user equipment devices not being restricted from dropping some scheduling occasions without network knowledge—also known as interruptions. The implementations and behavior of such devices in the field cannot be retroactively changed to assimilate to updated release levels. Certain embodiments described herein mitigate this issue by adapting the network to the various types of user equipment devices in use such that the network is able to behave and respond to the various devices with an understanding of how each device intends to function for a communication session before it begins.

According to an example embodiment, a user equipment device camped in LTE can indicate to the network that it does not need measurement gaps for performing NR (New Radio) inter-RAT (Radio Access Technology) measurements and hence indicates NFG (NeedForGaps) is False. However, some releases of the 3GPP Technical Specification Group Radio Access Network (RAN4) introduced a problem of different understanding of the expected user equipment device behavior and related requirements. One understanding was that if the user equipment device indicates that it does not need gaps for performing measurements, the measurements would be performed without interruptions. Another understanding was that if the user equipment device indicates that it does not need gaps for performing measurements during a communication session, such measurements would be performed without gaps but would include some allowed interruptions. Though there are no defined user equipment requirements allowing interruptions in this scenario. Further, the signaling does not indicate anything about whether the user equipment device would cause interruptions when performing measurements without gaps or not. Hence, the network can only assume all user equipment devices indicating that they can perform measurements without gaps will cause interruptions. User equipment devices not causing interruptions during a communication session are negatively affected by this presumption.

More recently, additional signaling was introduced to enable a user equipment device to indicate one of the following: measurement gaps are needed for measurements (on a band/carrier); no need for gaps and no interruptions for performing measurements (on a band/carrier); or no need for gaps but interruptions for performing measurements (on a band/carrier). This enables a user equipment device to indicate the device need for gaps during a communication session and whether the device would cause interruptions or not when performing measurements without gaps. This signaling provides full visibility to the network and the network can behave accordingly.

RAN4 has defined extensive user equipment device requirements related to measurements without measurement gaps and measurements using measurement gaps. These requirements include measurement delay and interruption ratio for numerous scenarios including intra-frequency measurements without gaps; intra-frequency measurements with gaps; inter-frequency measurements with gaps; and inter-frequency measurements without gaps. Inter-frequency measurements here also cover inter-RAT (Radio Access Technology) measurements. RAN4 has then also defined requirements for the scenario where the user equipment device is configured with a mix of having gap-assisted and non-gap-assisted measurements simultaneously. For this purpose, and due to having limited the measurement occasions to when SMTC (SS (Synchronization Signals)/PBCH (Physical Broadcast Channel) Block Measurement Timing Configuration) for the target carrier to be measured is present, RAN4 has defined how/when the user equipment device shall measure certain carriers within gaps and outside gaps depending on the device capability and measurement gap configuration.

The rules are currently defined and states which measurements are to be performed within gaps and which are to be performed outside of gaps. Whether the UE needs gaps for performing measurements on a certain carrier is a user equipment device capability and indicated in the network. The network has no influence on this.

In release 16 of RAN4, two features were defined for measurements without gaps. The first if there is a need for gaps which allows the user equipment device to signal whether gaps are needed when performing NR measurements. With this capability, the user equipment device can indicate whether gaps are needed in response to RRC (Radio Resource Control) configuration, therefore this indication can be adjusted depending on the network configuration. The capability of measuring without gaps in this case can depend on carrier aggregation configuration among other configurations.

The second feature is the interRAT need for gaps. This is a user equipment device capability for the user equipment device connected to an LTE network. With this capability, the user equipment device indicates whether the gaps are needed for measuring NR cells. The measurements performed without gaps may cause interruptions, which was not discussed in 3GPP until release 18.

To address the issues of user equipment devices operating in a manner that a network is not fully and optimally compatible with, certain embodiments described herein provide a mechanism by which user equipment devices supporting gapless measurements during a communication session may also cause interruption in order to perform such measurements. To do so, the framework identifying the need for measurement gaps is extended. The improved signaling design for the network configures an identifier concerning a need for interruption to which a user equipment device replies with information concerning the need for interruption. A single flag can be used to determine whether interruption is needed by the user equipment device when performing gapless measurements, which is complemented associated with the entry in a list regarding the interruption frequency.

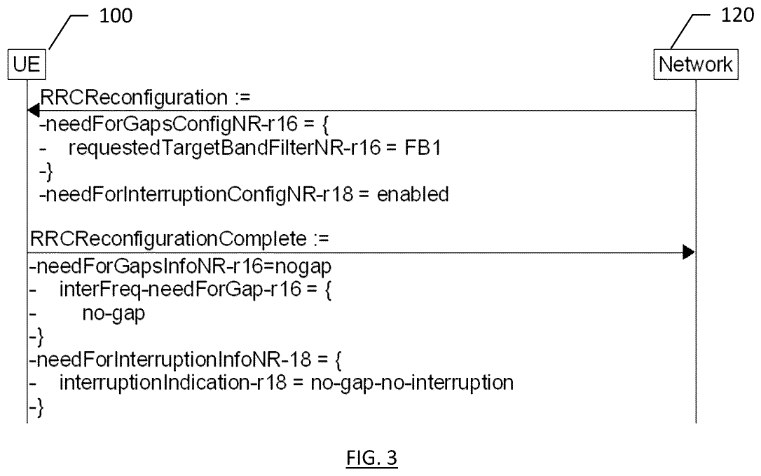

FIG. 3 illustrates a message flow chart between a user equipment device 100 and a network 120 at the start of a communication session. The Radio Resource Control (RCC) protocol uses signaling to configure measurement gaps in a network such that they do not coincide with device transmissions or receptions. As shown, the RCC Reconfiguration request is sent from the network 120 to the user equipment device 100 including the “needForGapsConfigNR-r16” with the “requestedTargetBandFilterNR-r16”. This requests the measurement gap information to the device against the target frequency bands, and the requirement for the frequency band, which is “FB1” in FIG. 3. The flag is provided for a “needForInterruptionConfigNR-r18” as to whether interruptions are needed. The user equipment device 100 sends the completed RRC Reconfiguration including the need for gaps and the need for interruptions to the network. In the illustrated embodiment, the configuration is no measurement gaps needed and no interruptions.

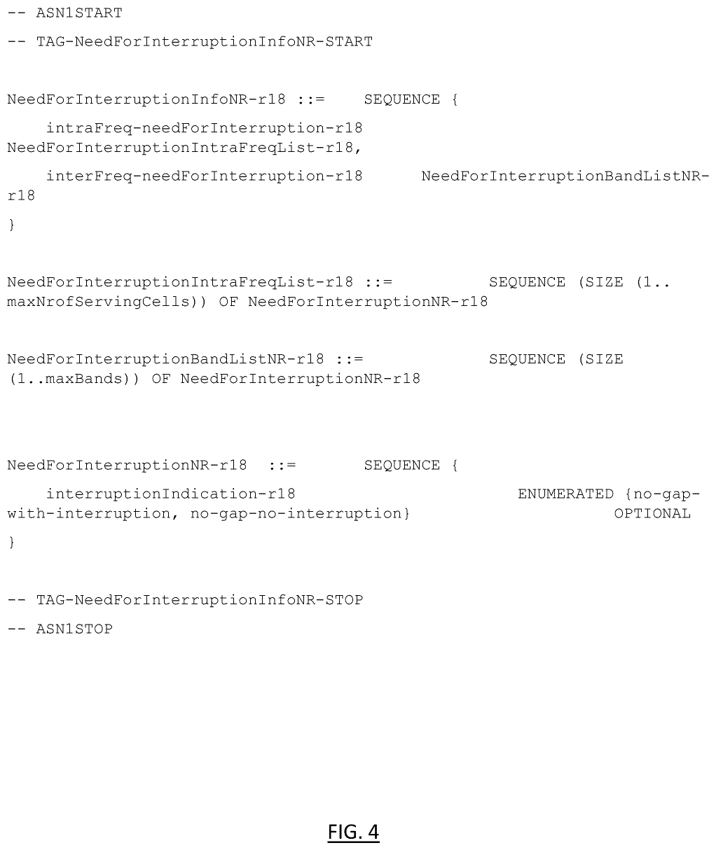

The “NeedForInterruptionInfoNR” of FIG. 3 indicates whether interruption is needed for the user equipment device to perform SSB based measurements on an NR target band without measurement gaps, while the NR-DC or NE-DC is not configured. An example embodiment of the “NeedForInterruptionInfoNR” element is depicted in FIG. 4. The “intraFreq-needForInterruption” indicates the interruption requirement information for NR intra-frequency measurement. Each entry in the list is associated to the entry in list “intraFreq-needForGap-r16” with the same index. The “interFreq-needForInterruption” indicates the interruption requirement information for NR inter-frequency measurement. Each entry in the list is associated to the entry in list “interFreq-needForGap-r16” with the same index. In the “NeedForInterruptionNR” field, the “interruptionindication” indicates whether interruption is needed for the user equipment device to perform SSB based measurements without measurement gap. Value “no-gap-with-interruption” indicates that interruption is needed. Value “no-gap-no-interruption” indications interruption is not needed. With this information, the network can be aware of which frequency layers require interruption in order to perform measurements without gaps.

Once the “NeedForGaps” information is shared by the user equipment device responsive to the network, the network infers which frequency layers are performing measurements with and without gaps based on the gap configuration and the UE report on which the target frequencies need gaps in “NeedForGapsInfo.”

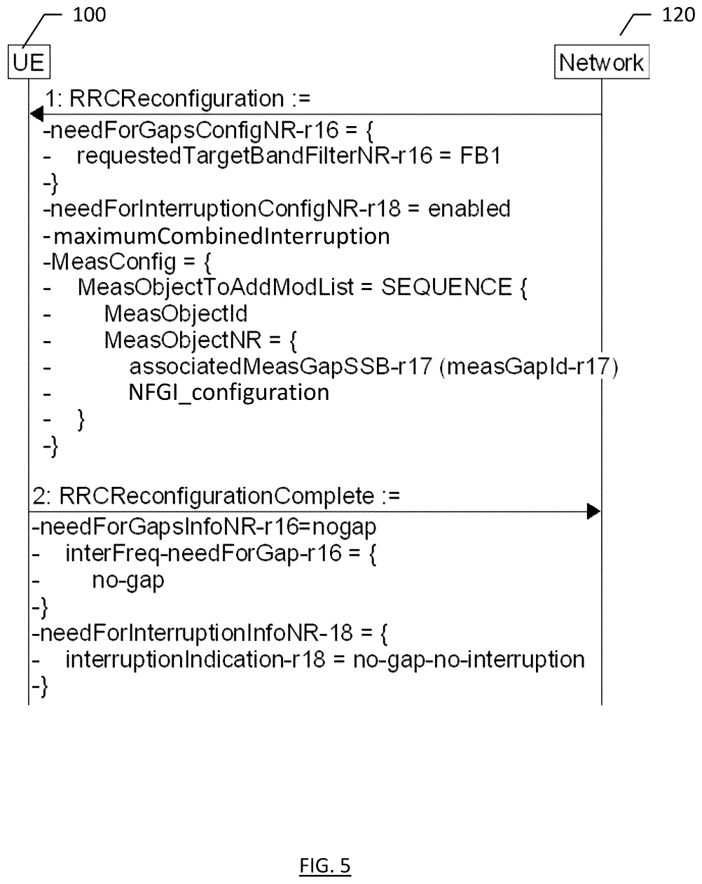

There is an interest in keeping the number of interruptions reduced for the gapless measurements. For this reason, measurements with interruptions may use a lower bound of 80 milliseconds for measurement cycle. That means that even if the network configures the SMTC to 20 milliseconds, the user equipment device will take samples at least every 80 milliseconds, which will imply in longer measurement delays. FIG. 5 illustrates such an example embodiment with a “maximumCombinedInterruption” field and an “NFGI_configuration” field included in the information requested by the network 120 of the user equipment device 100.

Certain embodiments provided herein include a method for signaling information of interruptions for user equipment devices supporting earlier operating systems, software versions, and firmware versions, such as those supporting the aforementioned “interRAT-NeedForGapsNR-r16” or “NeedForGapsInfoNR-r16”. Several solutions are provided herein and are presented based on whether they depend on more recent operating system, software, or firmware, such as R18 signaling (“interRAT-NeedForIntrNR-r18” or “NeedForInterruptionNR-r18”) or not.

A first example embodiment provided herein is independent of R18 signaling, meaning that the R18 user equipment device capability of whether interruptions are needed or not is not supported by the user equipment device. In this case, the solution described herein makes it possible for the device to indicate the level of interruptions which is NOT dependent on any of the user equipment device capabilities (e.g., R18) indicating need for gap interruptions.

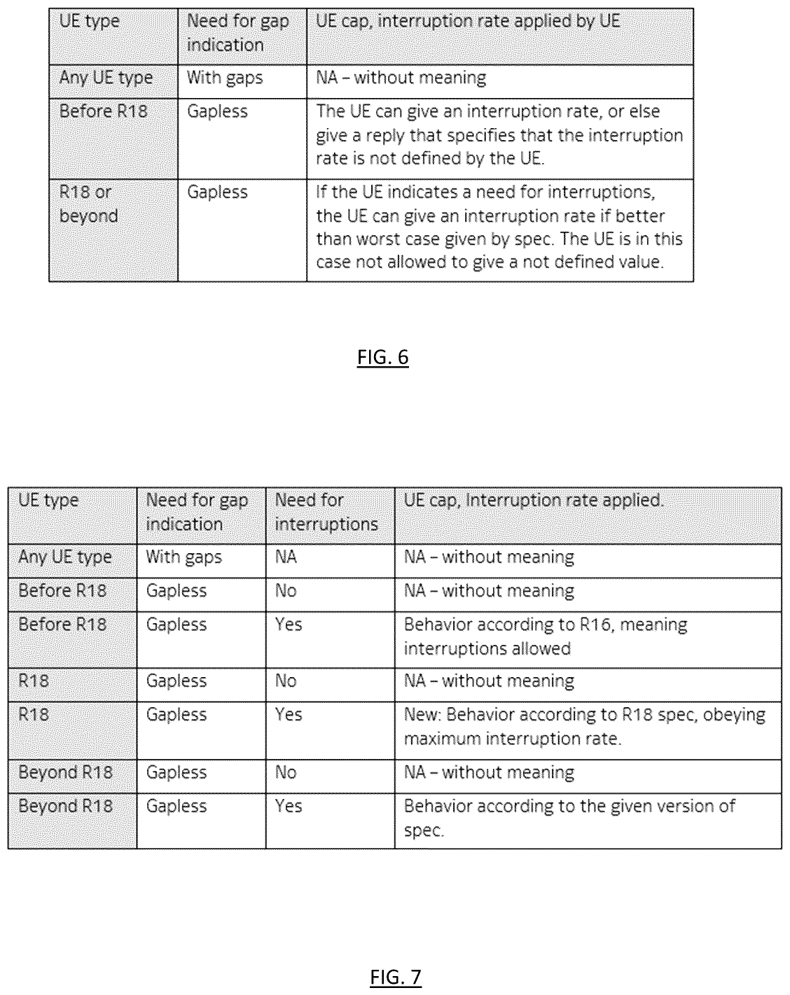

For any user equipment device type having a need for gaps indication, the interruption rate applied is not applicable. For a user equipment device that lacks R18 capabilities and is presumed to be gapless (e.g., not requiring measurement gaps), the user equipment device can provide an interruption rate or otherwise provide a reply to the network that specifies that the interruption rate is not defined by the user equipment device. For user equipment devices compatible with R18 capabilities, the device may indicate there is no requirement for measurement gaps during a communication session and the user equipment device can indicate a need for interruptions of the communication session. The user equipment device can provide an interruption rate if the rate is better than the worst case scenario provided in the release specification. This provided interruption rate is the permissible interruption rate for the user equipment device. The user equipment device in this case is not allowed to give a “not defined” value. FIG. 6 illustrates the aforementioned device type capabilities in a table. This solution does not depend on user equipment device capability to indicate a need for interruption if the user equipment device type is before R18.

Another solution provided herein is dependent upon user equipment device type signaling compatible with R18. In this solution, the device can link to the R18 or beyond device capabilities in giving need for interruptions when performing measurements without gaps. If the user equipment device is before R18 (early implementation of “nr-NeedFor InterruptionReport-r18” and/or “interRAT-NeedForIntrNR-r18”) it will indicate the type of behavior. If the device is R18 or beyond, another type of behavior of the device is given. Alternatively, the device can indicate whether an interruption rate is defined or not and what the maximum interruption rate will be.

FIG. 7 illustrates such an embodiment where the user equipment device behavior is provided if the device capability for interruption rate is given by the user equipment device. As shown, any user equipment device type that has a need for measurement gaps during a communication session does not require any interruptions or any interruption rate. User equipment device types before R18 that are gapless with no need for interruptions similarly does not define an interruption rate. User equipment device types before R18 that are gapless and require interruptions behave according to R16 meaning that interruptions are permissible. User equipment devices with R18 that are gapless and have no need for interruptions do not define an interruption rate. User equipment devices with R18 that are gapless (e.g., do not require measurement gaps during a communication session) and require interruptions behave according to the R18 specification obeying the defined maximum interruption rate. Beyond R18, devices that are gapless without need for interruption do not define an interruption rate, while those that require interruption behave according to the version of the specification provided by the device.

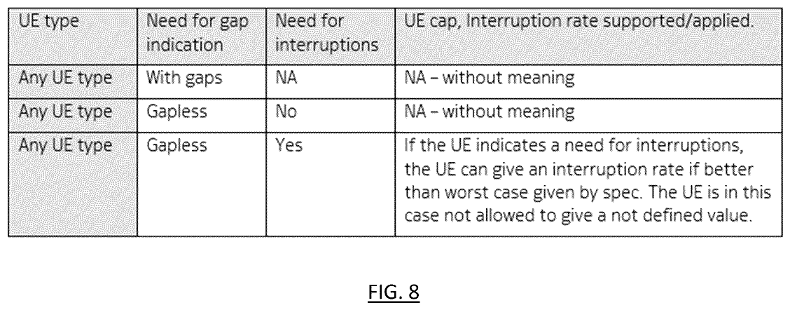

For devices that can indicate whether an interruption rate is defined or not and what the maximum interruption rate will be, the table of FIG. 8 illustrates how the interruption rate is supported or applied. As shown, user equipment devices of any type that require gaps do not have a need for interruptions and the interruption rate is not defined. Similarly, user equipment devices that are gapless and have no need for interruptions do not define an interruption rate. However, user equipment devices that are gapless and have a need for interruptions indicate the need, and the user equipment device can provide an interruption rate as a permissible interruption rate if better than the worst case scenario provided by the specification. The user equipment device in this case is not permitted to give an undefined value.

An advantage of some embodiments described herein is that the more the network understands about interruptions, the more options there are to mitigate the impact on the device and the network. The network is able to mitigate the impact of interruptions of the communication session based on the defined interruption rate which enables the network to reduce an impact of lost resources on the communication session. The network can employ artificial intelligence (AI) to find patterns of interruptions when it knows they are there and can thereby by itself apply scheduling restrictions when interruptions are detected. Knowing how many interruptions there are helps confirm the output of the AI solution, whether it is in line with what the user equipment device reports or not.

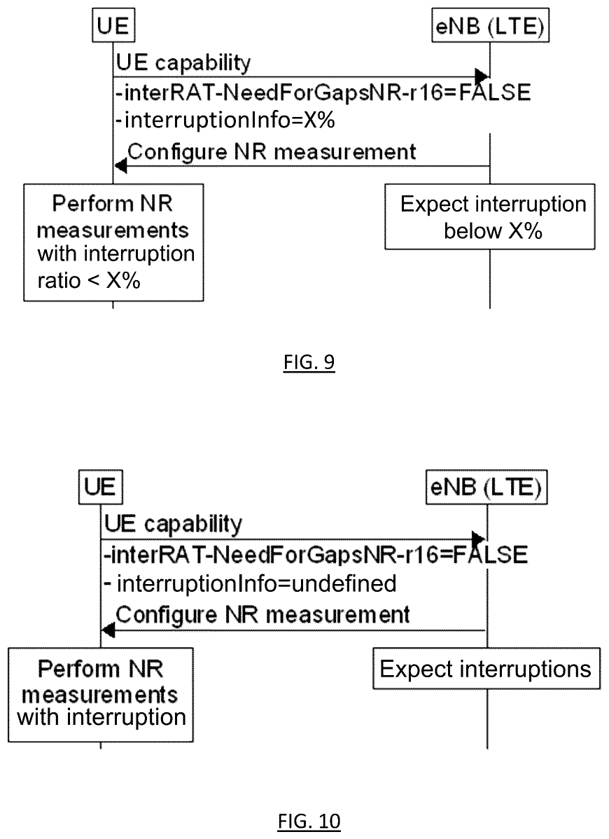

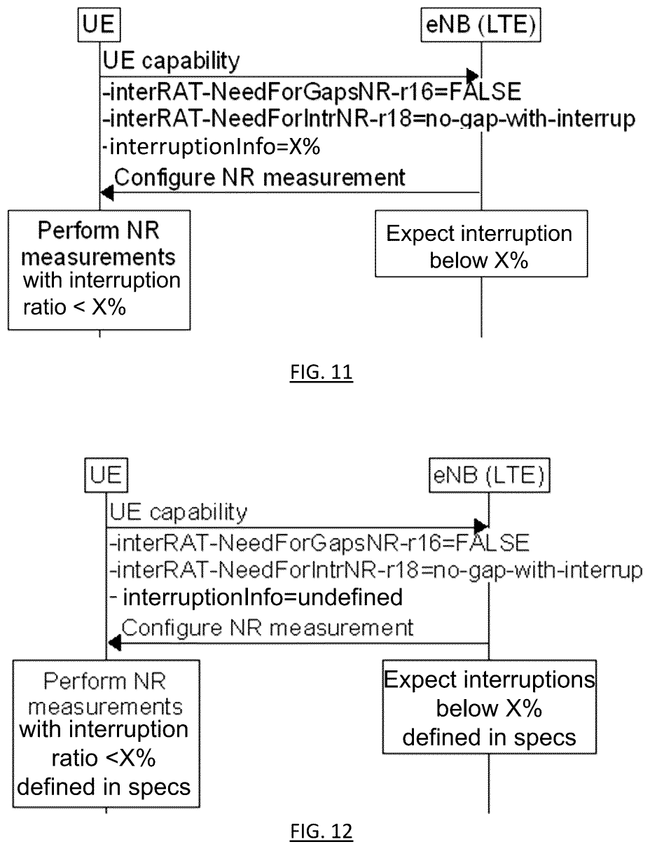

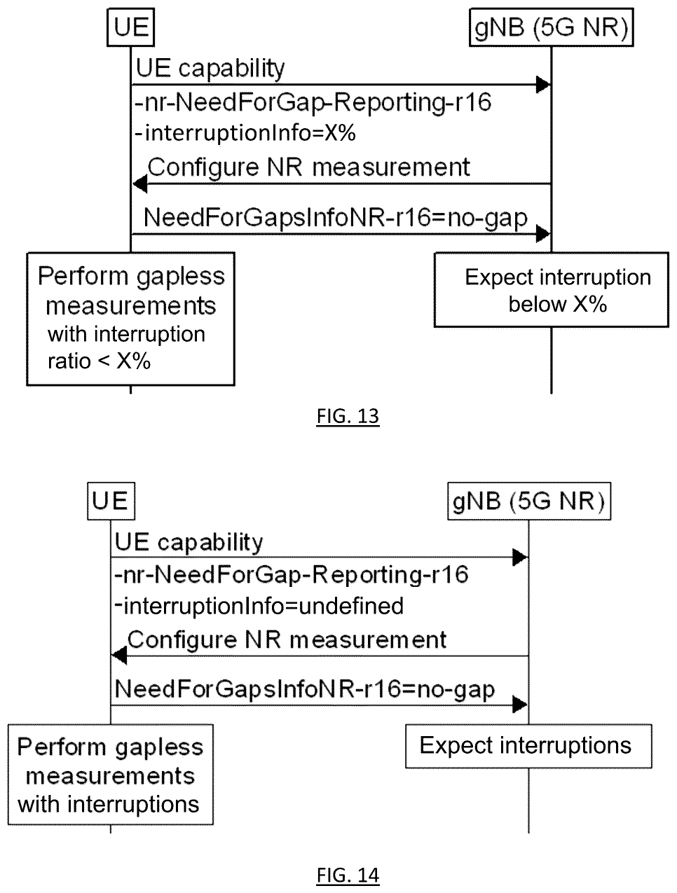

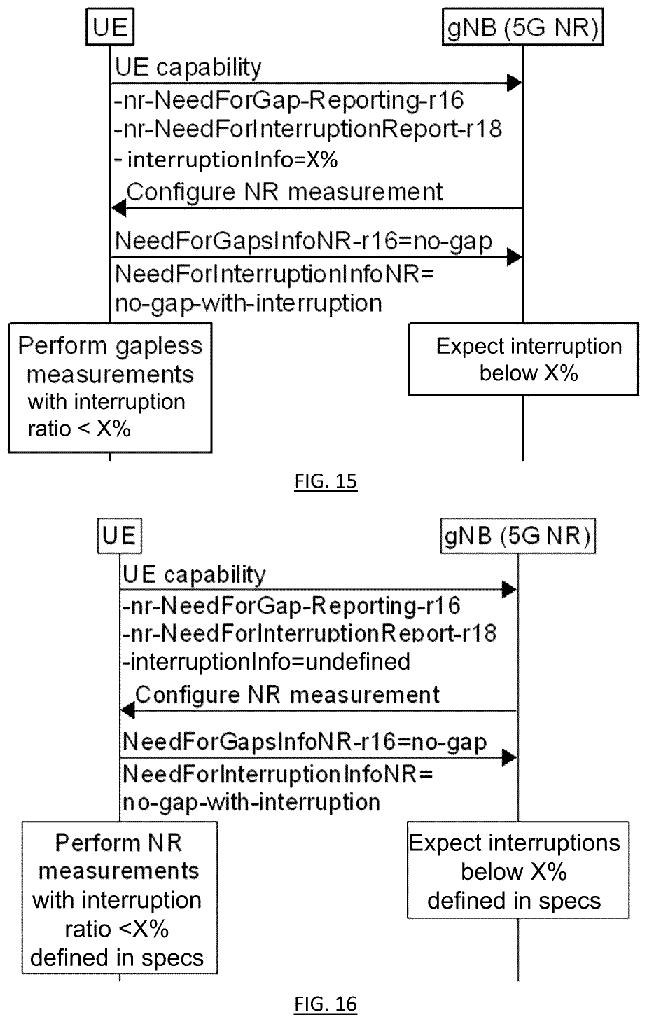

The following figures (FIGS. 9-16) illustrates scenarios for alternative embodiments described herein for user equipment devices connected in LTE network performing N measurements without gaps, and user equipment devices connected to NR network performing measurements without gaps. The changes between FIGS. 9-12 and FIGS. 13-16 relate to how the necessity for gaps is signaled for LTE and NR networks, with LTE networks being a fixed user equipment device capability and NR networks being a response to the RRC configuration. FIGS. 9-12 illustrate examples of solutions for a user equipment device in an LTE network performing NR measurements without gaps. For FIG. 11, the interruption rate X could be required to be below the rate given by the specification as shown in FIG. 12. FIGS. 13-16 illustrate examples for a user equipment device in a NR network performing measurements without gaps. For FIG. 15, the interruption rate X could be required to be below the rate given by the specification as shown in FIG. 16.

According to FIGS. 9-12 and 13, the user equipment device supports the “interRAT-NeedForGapsNR-r16” and “NeedForGapsInfoNR-r16” features and indicate an interruption ratio X %. In that case, the user equipment device should perform measurements without gaps with an interruption ratio smaller than X %. In FIGS. 9-12 and 14, the user equipment device only supports the “interRAT-NeedForGapsNR-r16” and “NeedForGapsInfoNR-r16” features and indicate an undefined interruption ratio. In that case the user equipment device should perform measurements without gaps with interruptions, but no information about the interruption ratio is shared. This means that the user equipment device may cause interruptions. In the aforementioned scenarios, the network can use the information that there are interruptions and the ratio (for the embodiment of FIG. 13) in order to optimize its algorithms.

According to FIGS. 9-12 and 15, the user equipment device supports the R18 features “interRAT-NeedForIntrNR-r18” or “NeedForInterruptionNR-r18”. In this situation, the user equipment device can use the new device capability “interruptionInfo” to inform the network of a lower interruption ratio than the one specified as the default interruption ratio in the specification. If the user equipment device indicates “interruptionInfo=undefined”, the expected interruption ratio is the one defined in the specification. According to some embodiments, only scenarios of FIGS. 13 and 14 are considered for implementation.

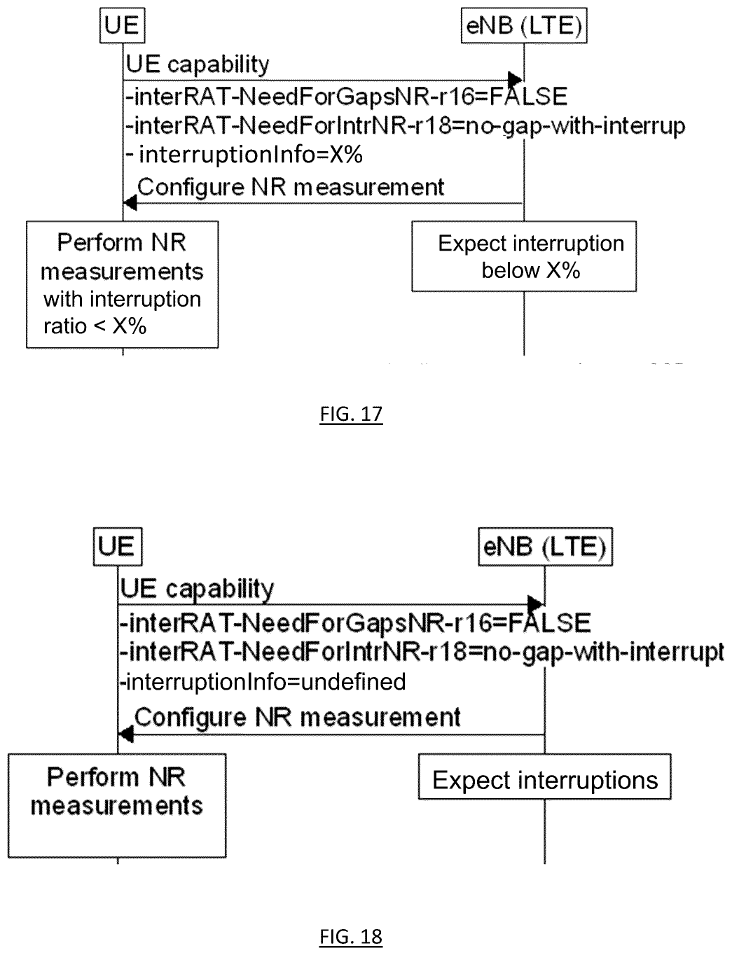

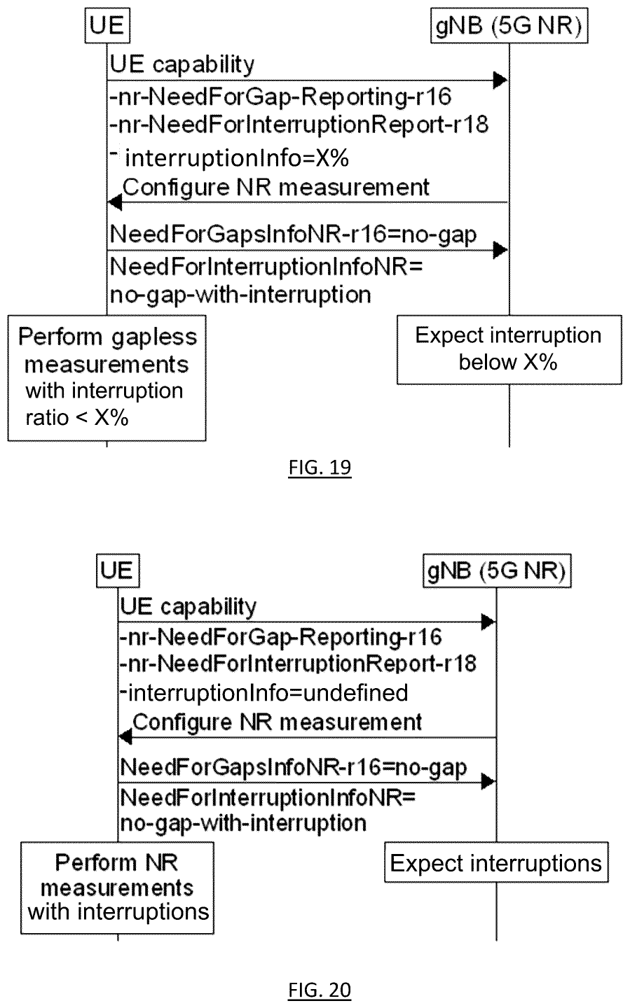

According to some embodiments, the user equipment device employs a combination of R16 and R18 signaling to indicate the need for gaps and interruptions. This signaling is enhanced by an additional user equipment device capability indicating interruption information. Certain example embodiments are depicted in the illustrations of FIGS. 17-20. In an example embodiment, the interruption ratio of X % may be provided, as shown in FIGS. 17-19. In this case, the user equipment device is required to perform gapless measurement with an interruption rate less than X %.

With an undefined interruption rate, as depicted in FIGS. 17-18 and 20, the user equipment device R18 indication of a need for interruptions is only indicating whether interruptions are needed, without a limit on how many interruptions may be caused. Certain example embodiments of alternatives depicted in FIGS. 17-20 may follow similar patterns with a difference on how the user equipment device capability is defined. For the embodiment in which the device can link to R18 or beyond capabilities in giving need for interruptions when performing measurements without gaps, the user equipment device capability can include: for R16 behavior—the device uses the R18 features for signaling the need for interruption, but the interruption behavior follows the R16 requirements; for R17 behavior—the device uses the R18 features for signaling the need for interruption, but the interruption follows the R17 requirements; for R18 behavior, the device follows the R18 signaling and requirements for interruption.

For some embodiments as depicted in FIGS. 17-20, the user equipment device capabilities can be defined. For a defined/undefined interruption ratio, the interruption ratio is defined as either limited or not. The interruption level, when defined, can define an interruption ratio of X % where the user equipment device is required to perform gapless measurement with an interruption ratio of less than X %. A default interruption level indicates that the interruption ratio defined for the specification is used, which for R18 is “needForInterruption”.

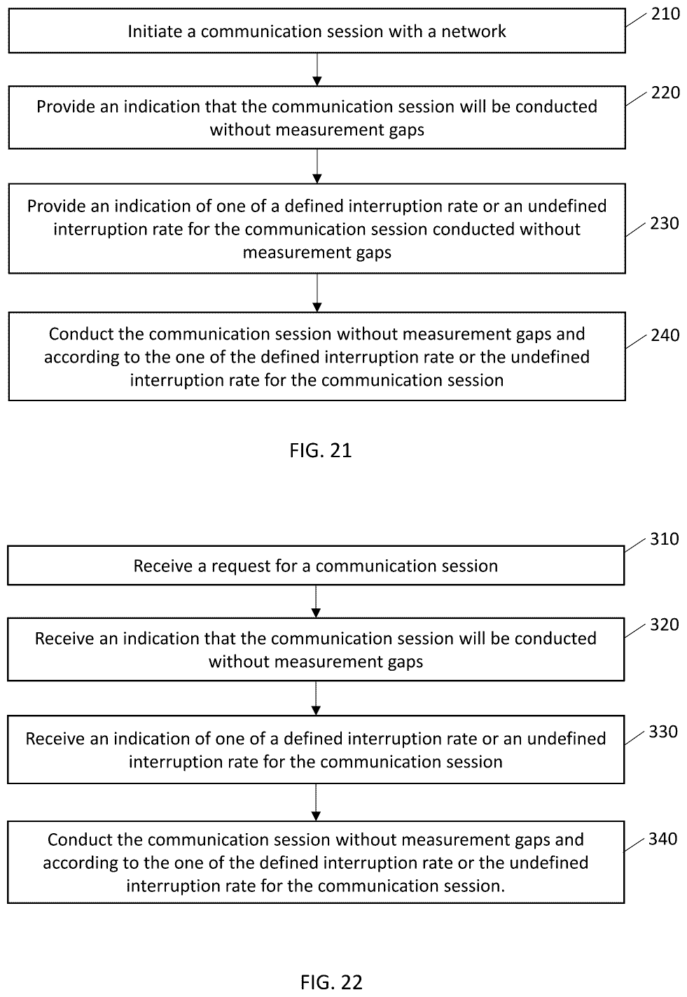

FIGS. 21-22 are flow charts illustrating the operations performed in order to provide for handling communication sessions without measurement gaps. Referring now to FIG. 21, a flow chart illustrating the operations performed, such as by the apparatus of FIG. 2 as embodied by a user device, in order to support communication sessions without measurement gaps is provided. In the example flow chart, a user device (e.g., UE, wireless device, etc.) may initiate a communication session at 210 with a network, such as via a base station (e.g., network, gNB, etc.). The apparatus of this example also includes means, such as the processing circuitry 22, the communication interface 26, and/or the like for providing an indication that the communication session will be conducted without measurement gaps as shown at 220. The apparatus of this example also includes means, such as the processing circuitry 22, the communication interface 26, and/or the like, for providing an indication of one of a defined interruption rate or an undefined interruption rate for the communication session conducted without measurement gaps at 230. The apparatus of this example also includes means, such as the processing circuitry 22, the communication interface 26, and/or the like, for conducting the communication session as shown at 240 without measurement gaps and according to the one of the defined interruption rate or the undefined interruption rate for the communication session.

Referring now to FIG. 22, a flow chart illustrating the operations performed, such as by the apparatus of FIG. 2 as embodied by a network entity, in order to provide for handling communication sessions without measurement gaps. In the example flow chart, a network entity (e.g., base station, gNB) may receive a request for a communication session at 310. The apparatus of this example also includes means, such as the processing circuitry 22, the communication interface 26, and/or the like, for receiving an indication that the communication session will be conducted without measurement gaps at 320. The apparatus of this example also includes means, such as the processing circuitry 22, the communication interface 26, and/or the like, for receiving an indication at 330 of one of a defined interruption rate or an undefined interruption rate for the communication session. The apparatus of this example also includes means, such as the processing circuitry 22, the communication interface 26, and/or the like, for conducting the communication session at 340 without measurement gaps and according to the one of the defined interruption rate or the undefined interruption rate for the communication session.

As described above, a method and apparatus are disclosed for handling communication sessions without measurement gaps, for example, where the apparatus may be the device 20 and the method may be any one of the methods of FIG. 21 or 22. By handling communication sessions without measurement gaps and understanding an interruption rate ahead of the communication session, the communication session can be conducted more efficiently and effectively without undesirable unexpected interruptions.

FIGS. 21-22 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present disclosure and executed by a processor. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims.

Moreover, although the foregoing descriptions and the associated drawings describe certain example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising:
at least one processor; and
at least one memory storing instructions that, when executed by the at least one processor, cause the apparatus to at least:
initiate a communication session with a network;
provide, to the network, an indication that the communication session will be conducted without measurement gaps;
provide an indication of one of a defined interruption rate or an undefined interruption rate for the communication session conducted without measurement gaps; and
conduct the communication session without measurement gaps and according to the one of the defined interruption rate or the undefined interruption rate for the communication session.

2. The apparatus of claim 1, wherein causing the apparatus to provide the indication of the one of the defined interruption rate or the undefined interruption rate comprises causing the apparatus to provide the indication of the defined interruption rate and a permissible rate of interruption.

3. The apparatus of claim 2, wherein the apparatus is further caused to:
receive an indication of a configuration from a network according to the indication of the defined interruption rate.

4. The apparatus of claim 3, wherein the apparatus is further caused to:
conduct the communication session with the network without measurement gaps and according to the indication of the defined interruption rate.

5. The apparatus of claim 4, wherein the apparatus is further caused to:
provide for interruptions of the communication session at a rate that does not exceed the permissible rate of interruption.

6. The apparatus of claim 5, wherein the interruptions of the communication session are provided in order to perform signal measurements.

7. The apparatus of claim 1, wherein causing the apparatus to provide the indication of the one of the defined interruption rate or the undefined interruption rate comprises causing the apparatus to provide the indication of the undefined interruption rate.

8. The apparatus of claim 7, wherein the apparatus is further caused to:
receive an indication of a configuration from a network according to the indication of the undefined interruption rate.

9. The apparatus of claim 7, wherein the apparatus is further caused to:
conduct the communication session with the network without measurement gaps according to the indication of the undefined interruption rate.

10. The apparatus of claim 9, wherein the apparatus is further caused to:
provide for interruptions of the communication session at a rate that does not exceed a permissible rate of interruption defined according to a specification associated with the apparatus.

11. The apparatus of claim 10, wherein the interruptions of the communication session are provided for performing signal measurements.

12. The apparatus of claim 9, wherein the apparatus is further caused to:
perform signal measurements as interruptions of the communication session at a rate that does not exceed a permissible rate of interruption defined according to a specification associated with the apparatus.

13. An apparatus comprising:
at least one processor; and
at least one memory storing instructions that, when executed by the at least one processor, cause the apparatus at least to perform:
receive a request for a communication session from a user equipment device;
receive an indication that the communication session will be conducted without measurement gaps;
receive an indication of one of a defined interruption rate or an undefined interruption rate for the communication session; and
conduct the communication session without measurement gaps and according to the one of the defined interruption rate or the undefined interruption rate for the communication session.

14. A method comprising:
initiating a communication session with a network;
providing, to the network, an indication that the communication session will be conducted without measurement gaps;
providing an indication of one of a defined interruption rate or an undefined interruption rate for the communication session conducted without measurement gaps; and
conducting the communication session without measurement gaps and according to the one of the defined interruption rate or the undefined interruption rate for the communication session.

15. The method of claim 14, wherein providing the indication of the one of the defined interruption rate or the undefined interruption rate comprises providing the indication of the defined interruption rate and a permissible rate of interruption.

16. The method of claim 15, further comprising:
receiving an indication of a configuration from a network according to the indication of the defined interruption rate.

17. The method of claim 16, further comprising:
conducting the communication session with the network without measurement gaps according to the indication of the defined interruption rate.

18. The method of claim 14, wherein providing the indication of the one of the defined interruption rate or the undefined interruption rate comprises providing the indication of the undefined interruption rate.

19. The method of claim 18, further comprising:
receiving an indication of a configuration from a network according to the indication of the undefined interruption rate.

20. The apparatus of claim 18, further comprising:
conducting the communication session with the network without measurement gaps according to the indication of the undefined interruption rate.
